(19) United States
(12) Patent Application Publication
(10) Pub. No.: US 2026/0194443 A1
(43) Pub. Date: Jul. 9, 2026

(54) PASSIVE AIR SENSOR ASSEMBLIES

(71) Applicant: Purpleair, Inc., Draper, UT (US)

(72) Inventor: Adrian Dybwad, Draper, UT (US)

(73) Assignee: Purpleair, Inc., Draper, UT (US)

(21) Appl. No.: 19/009,037

(22) Filed: Jan. 3, 2025

(51) Int. Cl. G01N 15/1434; G01N 15/14

(52) U.S. Cl. CPC G01N 15/1436; G01N 2015/1486

(57) ABSTRACT

The present disclosure is directed to passive sensor assemblies that use laser particle counters to sample air quality, including a sensor chamber where the sensor is sheltered inside a portion of the assembly and an air current is generated past the sensor by a heat sink used to cool the sensor. In one illustrative embodiment, the sensor chamber includes a sensor placed to monitor the air current as it passes through a bore formed in the heat sink. In some illustrative embodiments, the bore of the heat sink has a generally planar surface disposed in front of the sensor. In some such illustrative embodiments, the bore of the heat sink may have a polygonal shape, such as a square or rectangular cross section. The sensor chamber may be disposed in a body of the sensor assembly adjacent an opening of a passage that passes through the body.

### BACKGROUND

Current personal air quality sensors may use laser particle counters, with laser beams detect particles by their reflectivity. Such sensors count suspended particles in selected sizes, for example. These particle counts may be processed to calculate the PM mass in μg/m³. In an “active” sensor assembly the sensor is located inside a duct through which air is drawn by a fan, with noise generated by the fan operation. In known “passive” sensor assemblies, the sensor may be directly exposed to the surrounding environment and transient anomalies (such as a pet walking past the sensor) are more likely to result in incorrect readings, even where these readings are similarly transient.

A personal air quality sensor assembly that shelters the sensor from the surrounding environment while providing air movement past the center in a silent manner would be an improvement in the art. Such a sensor assembly that eliminates the need for a fan in an energy efficient manner would be a further improvement in the art.

### SUMMARY

The present disclosure is directed to passive sensor assemblies that use laser particle counters to sample air quality, including a sensor chamber where the sensor is sheltered inside a portion of the assembly and an air current is generated past the sensor by a heat sink used to cool the sensor. In one illustrative embodiment, the sensor chamber includes a sensor placed to monitor the air current as it passes through a bore formed in the heat sink. The sensor chamber may be disposed in a body of the sensor assembly adjacent an opening of a passage that passes through the body. The bore of the heat sink may be sized to contain the volume of air actively monitored by the sensor.

In some illustrative embodiments, the bore of the heat sink has a generally planar surface disposed in front of the sensor. In some such illustrative embodiments, the bore of the heat sink may have a polygonal shape, such as a square or rectangular cross section.

In some illustrative embodiments, the heat sink may be disposed in a body of the sensor assembly adjacent an opening of a passage that passes through the body. In some such embodiments, the heat sink bore may be aligned with parallel openings in opposite sides of a sensor assembly body.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

It will be appreciated by those of ordinary skill in the art that the various drawings are for illustrative purposes only. The nature of the present disclosure, as well as other embodiments of in accordance with the present disclosure, may be more clearly understood by reference to the following detailed description, to the appended claims, and to the several drawings.

FIGS. 1A and 1B depict bottom and side sectional views of a first embodiment of air quality analysis chamber arrangement for use in an air quality system in accordance with the principles of the present disclosure.

FIGS. 2A and 2B depict top and bottom perspective views of a first embodiment of an exemplary sensor assembly in accordance with the principles of the present disclosure.

FIGS. 3A and 3B depict top and bottom exploded perspective views of the components of the embodiment of FIGS. 2A and 2B.

FIG. 4 depicts a sectional side view of the embodiment of FIGS. 2A through 3B.

FIGS. 5A and 5B depict front and rear perspective assembled views of a second exemplary embodiment of a sensor assembly in accordance with the principles of the present disclosure.

FIG. 5C depicts a front perspective exploded view of the exemplary embodiment of FIGS. 5A and 5B.

### DETAILED DESCRIPTION

The present disclosure relates to apparatus, systems and methods for air quality monitoring. It will be appreciated by those skilled in the art that the embodiments herein described, while illustrating certain embodiments, are not intended to so limit this disclosure or the scope of the appended claims. Those skilled in the art will also understand that various combinations or modifications of the embodiments presented herein can be made without departing from the scope of this disclosure. All such alternate embodiments are within the scope of the present disclosure.

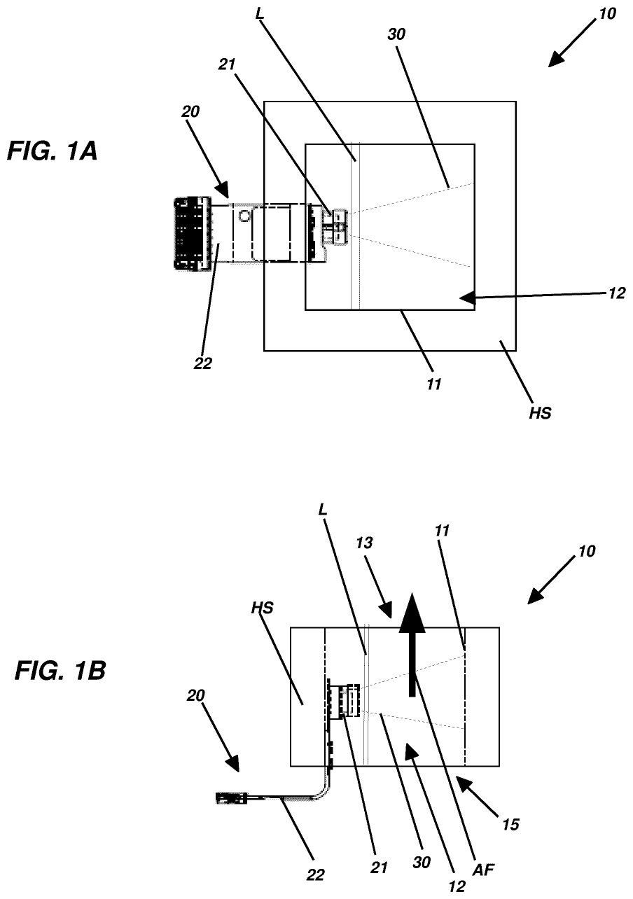

FIGS. 1A and 1B depicts one illustrative embodiment a sensor chamber 10 for use in an air quality sensor system or assembly in accordance with the present disclosure. It will be appreciated that systems in accordance with the present invention are intended to operate when positioned in different ways and the used of the positional terms including “upper”, “lower”, and the like are used solely for positional clarity in describing the depicted embodiments.

As depicted, sensor chamber 10 includes a heat sink HS, that has a surrounding sidewall 11 defining a central bore 12 with an upper opening 13, and an opposite lower opening 15. In the depicted embodiment, the bore 12 and the heat sink 11 have a square shape when viewed or below. It will be appreciated that alternate embodiments, where a different polygonal shape or a rounded shape maybe used.

An air quality sensor 20, including a laser and lens portion 21 and a body portion 22. The sensor 20 is placed adjacent to the sidewall 11, with the laser and lens portion 21 positioned such that the viewing area of the lens, indicated by dotted lines 30, is contained within the bore 12. Viewing area 30 is typically conical, and where the sidewall 11 defines a planar portion opposite lens, the heat sink is preferably sized to such that the boundaries of the viewing area are reside thereon.

Sensor 20 is secured in position and is in communication with the heat sink HS such that heat generated by the operation of the sensor 20 is conducted into the heat sink HS. For example, a thermally conductive epoxy may be used to adhere the sensor 20 to the wall of the bore 12 in the appropriate position. Body portion 22 may extend out of the bore 12 for connection to suitable circuity for the operation of the sensor. In the depicted embodiment, the body portion 22 may be flexible and be bent around the bottom surface of the heat sink HS for connection. One suitable sensor may be the Bosch BMV-080, which is commercially available.

As the sensor 20 is operated, heat generated by the sensor 20 is conducted into the heat sink HS, cooling the sensor and allowing it to continue to operate. Heat sink HS then dissipates the heat via conversion, into the surrounding air that can contact the sidewalls 11. The heating of air in the bore 12 generates airflow as indicated by arrow AF as the heated air rises to pass out the upper opening 13 and cooler air enter via lower opening 15, as depicted in FIG. 1B. It will be appreciated that when chamber 10 is disposed in the opposite position, the airflow will be generated with the respective openings serving in in the opposite manner. Additionally, when the chamber 10 is placed at an angled, or sideway position, the heat dissipation will generate airflow through the openings as the heated air rises and is replaced by cooler air from the surroundings.

The heat sink 11 may be constructed from suitable material to perform the functions discussed herein, including the conduction of heat generated by the sensor 20 away therefrom and dissipation of the conducted into the air. For example, the heat sink may be constructed from aluminum with an anodized surface, or another suitable heat conductive material.

As discussed further herein, the sensor 20 may be sheltered from the remainder of the bore 12 to provide additional protection to the laser and lens portion 21. In the depicted embodiment, a lens member L extends through the bore 12 in front of the sensor 20. The lens member will be transparent or translucent to allow the senor to operate therethrough.

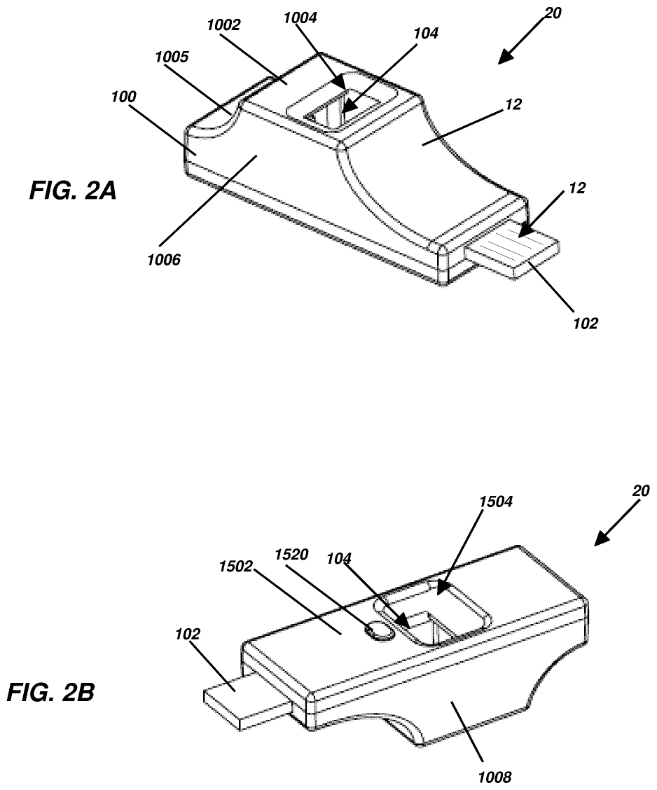

Referring to FIGS. 2A and 2B, a first sensor assembly 20 is depicted, which uses a sensor chamber in accordance with the present disclosure. As depicted, the sensor assembly 20 has a body 100, with an upper surface having a generally planar portion 1002 and an opposite lower surface having a generally planar portion 1502. Two opposite side surfaces 1006 and 1008 form the sides of the body. It will be appreciated that systems in accordance with the present invention are intended to operate when positioned in different ways and the used of the positional terms including “upper”, “lower”, and the like are used solely for positional clarity in describing the depicted embodiments.

In the depicted embodiment, at a first end, a connection member 102 extends from the body 100. As depicted, the connection member 102 may be a planar member with electrical traces 1315 disposed thereon. In the depicted embodiment, the planar member 102 is sized such that when it is inserted into a USB port, the traces 1315 make contact therein, allowing the assembly 10 to be powered through the USB port. It will be appreciated that in some embodiments, communication can be established between the sensor assembly 20 and a computer in operative communication with a USB port into which the connection member 102 has been inserted. It will be further appreciated that in other embodiments, different connection members may be used allowing connection to different ports or other power sources.

An upper opening 1004 is formed in the planar portion of the upper surface 1002 and a corresponding lower opening 1504 is formed in the planar lower surface 1502 with a passage 104 extending therebetween which allows air to flow through the bore of the sensor chamber. A button 1520 may be accessible at the lower surface 1502 to allow for control of the assembly 100. It will be appreciated that the shape of the body may vary for different embodiments, as may be desired for different appearances or for placement in certain locations. All such alternate embodiments are contemplated within the scope of the present disclosure.

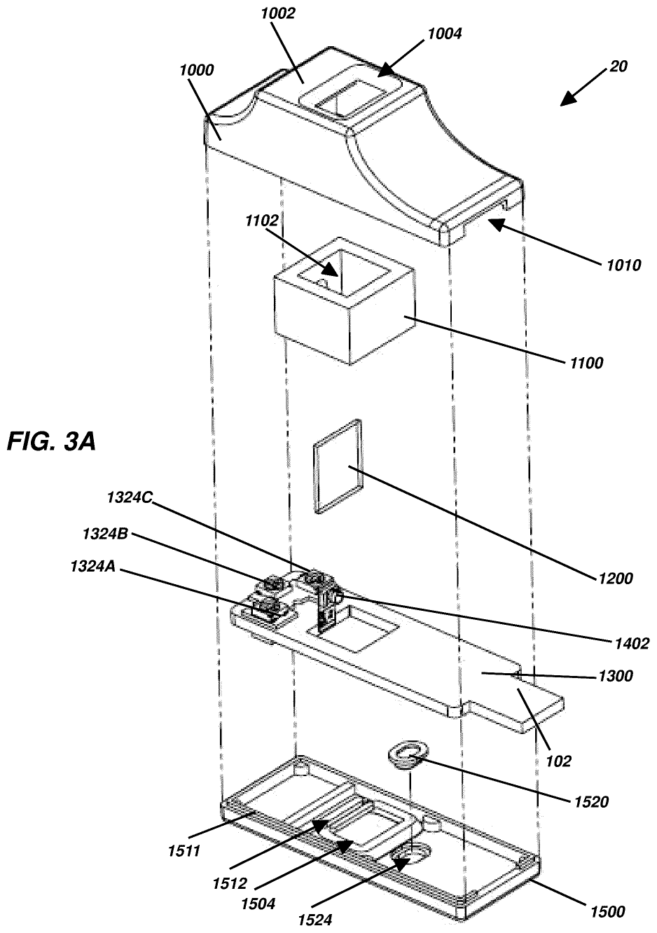

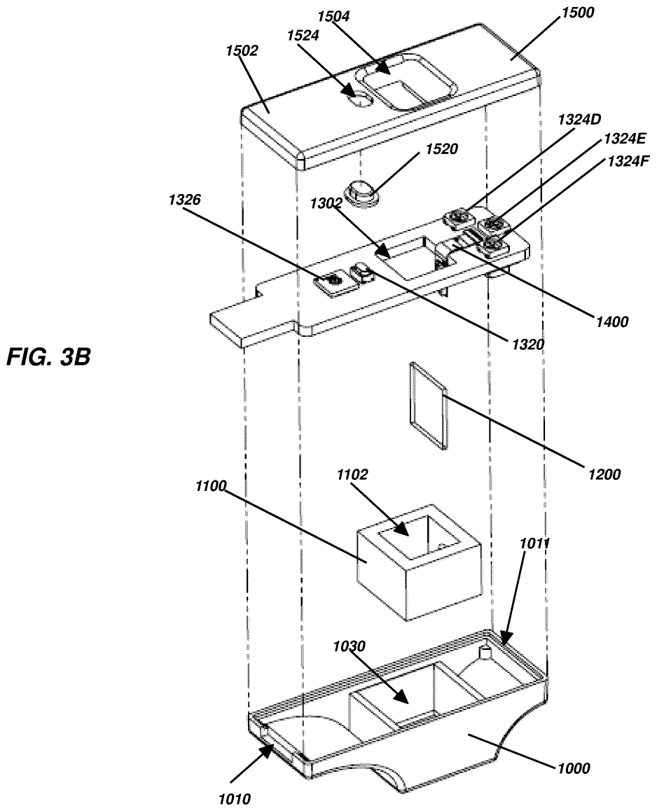

Turning to FIGS. 3A, 3B, and 4, various components of sensor assembly 20 are depicted in exploded and assembled form. In the depicted embodiment, the outer surface of the body 100 as discussed previously herein may be formed by an upper body member 1000 and a lower body member 1500 that are joined to one another to form body 100 and contain the remaining components.

Upper body member 1000 includes upper surface 1002 and upper opening 1004 and a lower open end. In the depicted embodiment, a front curved surface 1007 may extend forwards and downwards from the planar portion of the upper furnace to a generally vertical portion at the front end which includes a recess 1010 for connection member 102. Similarly, a rear curved surface 1005 may extend rearwards and downwards from the planar portion of the upper furnace to a generally vertical portion at the rear end. Two planar opposite sides 1006 and 1008 extend form the upper surface downward to the open bottom.

As best depicted in FIG. 3B, inside the open bottom one or more connection structures may be disposed for connection to the lower body member 1500. In the depicted embodiment a connection seat 1011 for receiving an insertion member 1511 on the lower body member is disposed around the rim of the open bottom.

The upper member 100A may include alignment structures for the heat sink 1100. In the depicted embodiment, a sink seat 1030 is formed as a set of walls extending downwards form the internal side of the upper surface, which correspond to the shape of the heat sink 1100.

Lower body member 1500 includes lower surface 1502 and lower opening 1504 and an open upper end, surrounded by a sidewall. The shape of the lower member 1500 corresponds to the open bottom of the upper member. One or more connection members may be present to facilitate connection to the upper body member. In the depicted embodiment, insertion member 1511 is formed as an alignment ridge or a small wall disposed on the sidewall for insertion into connection seat, with a gap corresponding to recess 1010. In the depicted embodiment, a button opening 1524 is also formed in lower surface, and separate button member 1520 is placed to extend therethrough, allowing it to be selectably actuated.

A central member 1300 may serve as a base for the connection of the remaining functional components of the assembly. The central member 1300 may be a planar member such as a circuit board to which electronic components are attached. The central member 1300 may include connection member 102 formed as a proximal end thereof that extends beyond the upper and lower body members through recess 1010. A central opening 1302 formed as a bore extends through the central member and is aligned with upper opening 1004 and lower opening 1404. In the depicted embodiment the central opening 1302 has a generally square shape, similar to that of the upper and lower openings and to form a portion of the sidewalls of the passage 104.

Functional electronic components may be disposed on the central member 1300, including LED light assemblies 1324A, 1324B, 1324C, 1324D, 1324E and 1324F, as well as a processer 1326 and a user interface, such as a button assembly 1320, which may be a momentary switch, allowing a single button to perform multiple functions. As depicted, the button assembly 1320 may be aligned with button member 1520 to allow for its activation. The LED light assemblies may be multicolor LED assemblies that can be actuated to emit different color lights, such as RGB (red/blue/green) assemblies. Where the body members 1000 and 1500 (or portions thereof) are formed of translucent or transparent material the light emitted by the LED assemblies may be visualized therethrough.

Suitable circuitry may be formed in, or disposed on, the central member to allow the various electronic components to function and to communicate with a computer through the connection member 102.

A sensor 1400 and heat sink 1100 are present and arranged as discussed in connection with FIGS. 1A and 1B to form a sensor chamber.

Heat sink 1100 has a surrounding sidewall defining a central bore 1102 with an upper opening 13, and an opposite lower opening 15. In the depicted embodiment, the bore 1102 and the heat sink 1100 have a square shape when viewed or below. It will be appreciated that alternate embodiments, where a different polygonal shape or a rounded shape maybe used.

Sensor 1400 may include a laser and lens portion 1402 and a longer flexible body 1404. One suitable sensor may be the Bosch BMV-080, which is commercially available. As depicted, in the illustrative embodiment, the sensor 1400 is positioned with the body 1404 extending through central passage 1302 and communicatively connected to the central member on the lower side thereof, with the lens portion positioned upright in the in the central passage 104. In the depicted embodiment, a thermally conductive adhesive is used to secure the sensor 1400 to the heat sink 1100.

The heat sink 1100 may be constructed from suitable material to perform the functions discussed herein, including the conduction of heat generated by the sensor 1400 away therefrom and dissipation of the conducted into the air. As depicted, the heat sink 1100 is secured in the remainder of the assembly 20 such that at least a portion of the internal walls of the bore 1102 are exposed to the air to allow the senor to function. In the depicted embodiment, the remainder of the heat sink 1100 is covered by other components of the assembly. This may vary based on the particular embodiment, do long as sufficient airflow is generated within the bore 1102.

Lens member 1200 formed as a sheet of transparent or translucent material extends through the bore 1102 of the heat sink 1100 and defines a protected space for the sensor 1400 lens portion 1402. Corresponding lens seats 1012 and 1512 in the upper and lower members 1000 and 1500 hold the lens member 1200 in position.

The lens member 1200 and the exposed portion of the heat sink 1100 walls in bore 1102 form the remainder of the inner portion of the chamber 104 sidewalls.

As best depicted in FIG. 4, sensor 1400 is placed adjacent to the sidewall of heat sink 1100, with the laser and lens portion 1402 positioned such that the viewing area of the lens, indicated by dotted lines 30A, is contained within the bore 1102. Viewing area 30A is typically conical, and where the sidewall 1101 defines a planar portion opposite the lens, the heat sink is sized to such that the boundaries of the viewing area reside thereon. Lens member 1200 extends through bore 1102 to define a protected chamber 4000 for the sensor 1400.

As discussed previously herein, sensor 1400 is secured in position and is in communication with the heat sink 1100 such that heat generated by the operation of the sensor 1400 is conducted into the heat sink 1100, as by a thermally conductive epoxy. As the sensor 1400 is operated, heat generated by the sensor 1400 is conducted into the heat sink 1100 within the protected chamber 4000, cooling the sensor and allowing it to continue to operate. Heat sink 1100 then dissipates the heat via convection in the bore 1102 The heating of air in the bore 1102 generates airflow as the heated air rises to pass out of the bore 1102 and cooler air to replace it. It will be appreciated that the assembly may be operated in any position as the heat dissipation will generate airflow through the openings as the heated air rises and is replaced by cooler air from the surroundings.

In operation, a sensor assembly 20 is configured to use the sensor 1400 as a to monitor air quality. Sensor 1400 operates as a laser particle counter, utilizing laser beams to detect particles by their reflectivity within the bore 1102. The sensor counts suspended particles in selected sizes ranges. For example, selected sizes could include particles of 0.3, 0.5, 1.0, 2.5 and 10 μm, or any combinations thereof. These particle counts are then processed by the sensor assembly processor using an algorithm to calculate air quality. For example, the laser scattering principle may be used to detect the concentration of particulate matter such as PM2.5 and PM10 in the air. The assembly 20 may be configured to use thee LED assemblies to display a color associated with the calculated air quality. For example, where the LED assemblies are RGB assemblies they may display a color corresponding to the USEPA AQI color codes index to provide a user and visual indication of air quality. It will be appreciated that where the upper and/or lower members are formed from translucent or transparent materials, that the displayed colors may be easily visualized. Additionally, the calculated results may be stored in the assembly or accessed by the USB connection or as is otherwise known to those if skill in the art.

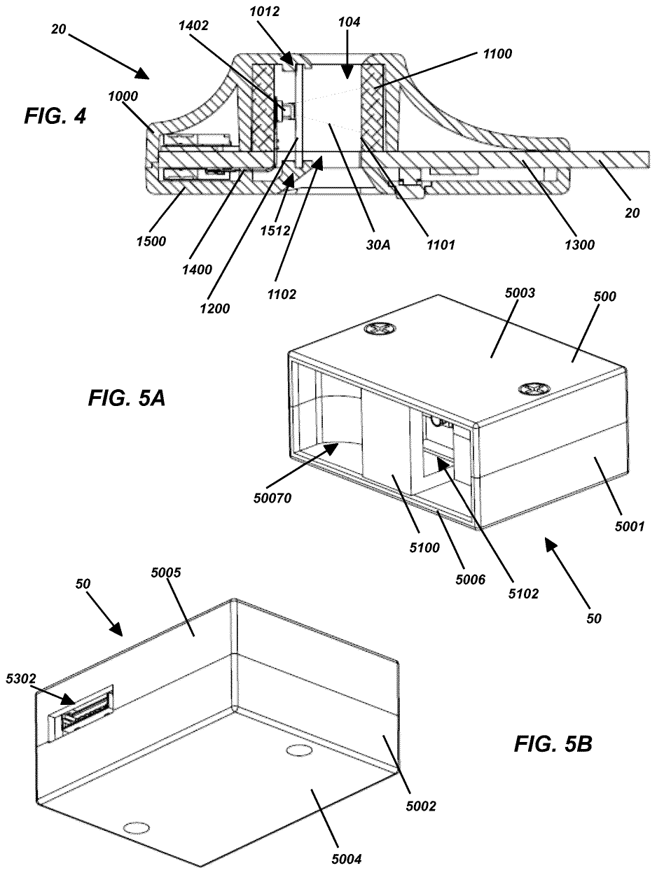

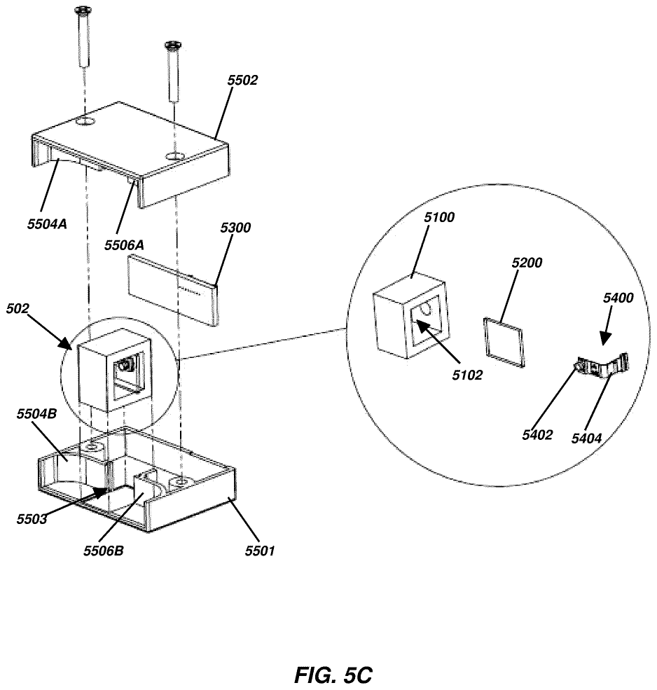

Turning to FIGS. 5A, 5B, and 5C, an embodiment of an assembly 50 in accordance with the present disclosure is depicted. A body 500 formed from a suitable material houses the remaining components. As body 500 has a generally rectangular cubic shape, having two opposite side surfaces 5001 and 5002, top side 5003, bottom side 5004, rear side 5005 and front side 5006. It will be appreciated that systems in accordance with the present disclosure are intended to operate when positioned in different ways and the used of the positional terms including “top”, “bottom”, and the like are used solely for positional clarity in describing the depicted embodiments. It will be further appreciated that the shape of the body may vary for different embodiments, as may be desired for different appearances or for placement in certain locations. All such alternate embodiments are contemplated within the scope of the present disclosure.

As depicted, front side 5006 is recessed to form a channel 5007. Heat sink 5100 includes a bore 5102, with sensor 5400 disposed therein, as discussed in connection with the precious embodiments to form a sensor chamber 502 for monitoring air quality, which is disposed in body 500 such that air flow through channel 5007 flows through the bore of sensor chamber 5102.

As best depicted in FIG. 5C, the outer surface of the body 500 as discussed previously herein may be formed by an upper body member 5502 and a lower body member 5501 that are joined to one another to form body 500 and contain the remaining components.

Upper body member 5502 and counterpart lower body member 5501 includes counterpart structures that define the body sidewalls, including curved inner walls 5504A and 5506A (on upper body member 5502) 55054B and 5506 (on lower body member 5501) on either side of sink seat 5503 for securing the heat sink 5100, which join to that define the curved inner wall of channel 5005. Sink seat 5503 may be formed as two opposite recesses in the upper and lower body members to position the heat sink 5100.

A sensor 5400 and heat sink 5100 are present and arranged as discussed in connection with FIGS. 1A and 1B to form a sensor chamber 502. As discussed previously herein, heat sink 5100 has a surrounding sidewall defining a central bore 5102 with opposite openings 510. In the depicted embodiment, the bore 5102 and the heat sink 5100 have a square shape when viewed or below. It will be appreciated that alternate embodiments, where a different polygonal shape or a rounded shape maybe used.

Sensor 5400 may include a laser and lens 5402 portion and a longer flexible body 5404. One suitable sensor may be the Bosch BMV-080, which is commercially available. As depicted, in the illustrative embodiment, the sensor 5400 is positioned with the body 5404 extending through bore 5102 for communicative connection and the central member on the lower side thereof, with the laser and lens portion 5402 positioned in the bore 5102. Where appropriate, a thermally conductive adhesive may be used to secure the sensor 5400 to the heat sink 5100.

The heat sink 5100 may be constructed from suitable material to perform the functions discussed herein, including the conduction of heat generated by the sensor 5400 away therefrom and dissipation of the conducted into the air. As depicted, the heat sink 5100 is secured in the remainder of the assembly 50 such that at least a portion of the internal walls of the bore 5102 are exposed to the air to allow the senor to function. This may vary based on the particular embodiment, do long as sufficient airflow is generated within the bore 1102.

Lens member 5200 formed as a sheet of transparent or translucent material extends through the bore 5102 of the heat sink 5100 and defines a protected space for the sensor 5400 laser and lens portion 5402. Corresponding lens seats 5013 and 5514 in the upper and lower members 5501 and 5502 hold the lens member 5200 in position. The lens member 5200 aligns with curved walls 5504 and 5506 to form the remainder of the inner portion of the curved channel 5005.

A circuit board 5300 may be present and serve as a base for the connection to the electronic components of the sensor 50, including a port 5302 for connection to a computer or other date collection device and/or to provide power to the system 50. Functional electronic components may be disposed on oni communication with the circuit board 5300, including LED light assemblies, as well as a processer and a user interface, as discussed previously herein. In connection with other embodiments. Suitable circuitry may be formed in, or disposed on, the central member to allow the various electronic components to function and to communicate with a computer using an appropriate connection, such as a cable connected to port 5302. In some other embodiments, the system may contain appropriate components for allowing a wireless connection, such as a Bluetooth or other wireless data transmission protocol.

It will be appreciated that additional embodiments where the bore of a sensor chamber as discussed previously herein is accessible to the air surrounding an assemble are contemplated and within the scope of the present disclosure. For example, an assembly where the heat sink and sensor are contained internally with suitable flues or passages aligned with the bore of the heat chamber.

While various aspects and embodiments have been disclosed herein, other aspects and embodiments are contemplated. The various aspects and embodiments disclosed herein are for purposes of illustration and are not intended to be limiting. Accordingly, other embodiments may be within the scope of the following claims. Unless otherwise noted, the terms “a” or “an,” as used in the specification and claims, are to be construed as meaning “at least one of.” Additionally, the words “including,” “having,” and variants thereof (e.g., includes, include, have, and has) as used herein, including the claims, shall be open-ended and have the same meaning as the word “comprising” and variants thereof (e.g., “comprise” and “comprises”).

What is claimed is:

1. A sampling chamber assembly for an air quality sensor system, the assembly comprising:
a heat sink defining a bore with a first opening, a second opening and at least one sidewall exposed to air within the bore;
a laser particle counting sensor, including a laser and lens assembly for detecting particles suspended in air, at least the laser and lens assembly of the laser particle counting sensor disposed in the bore of the heat sink, such that on actuation it will monitor the air quality in the bore; and
wherein the laser particle counting sensor is in thermally conductive contact with the heat sink, such that heat generated by the operation of the laser article counting sensor is conducted into the heat sink to the at least one sidewall exposed within the bore, thereby generating airflow in the bore.

2. The sampling chamber assembly of claim 1, wherein the at least one sidewall comprises a generally planar surface in front of the laser and lens assembly of the laser particle counting sensor.

3. The sampling chamber assembly of claim 2, wherein the bore has a polygonal shape along an axis parallel to the first opening and the second opening.

4. The sampling chamber of claim 1, further comprising a lens member disposed in the bore in front of the laser and lens assembly of the laser particle counting sensor.

5. The sampling chamber of claim 1, wherein the laser particle counting sensor is attached to the heat sink with a thermally conductive adhesive.

6. An air quality sensor system, the assembly comprising:
a body including a channel for the passage of air from the surrounding area;
a heat sink defining a bore with a first opening and an opposite second opening, the bore of the heat sink aligned with the channel, wherein at least a first sidewall of the heat sink is exposed to the air within the bore;
a laser particle counting sensor, including a laser and lens assembly for detecting particles suspended in air, at least the laser and lens assembly of the laser particle counting sensor disposed in the bore of the heat sink, and in thermally conductive contact with the heat sink, such that heat generated by the operation of the laser article counting sensor is conducted into the heat sink;
wherein upon actuation, heat generated by the laser particle counting sensor is released by the heat sink within the bore, thereby generating airflow through the channel.

7. The air quality sensor system of claim 6, wherein the at least one sidewall comprises a generally planar surface in front of the laser and lens assembly of the laser particle counting sensor.

8. The air quality sensor system of claim 7, wherein the bore has a polygonal shape along an axis parallel to the first opening and the second opening.

9. The air quality sensor system of claim 8, wherein the heat senor and the bore each have a generally square cross-sectional shape.

10. The air quality sensor system of claim 6, further comprising a lens member disposed in the bore in front of the laser and lens assembly of the laser particle counting sensor.

11. The air quality sensor system of claim 6, wherein the laser particle counting sensor is attached to the heat sink with a thermally conductive adhesive.

12. The air quality sensor system of claim 6, wherein the channel comprises a passage through the body.

13. The air quality sensor system of claim 6, further comprising a processor and at least one LED assembly configured to provide a colored illumination indicating a detected air quality.

14. An air quality sensor system, the assembly comprising:
a body including a channel for the passage of air from the surrounding area;
a heat sink defining a bore with a first opening and an opposite second opening, the bore of the heat sink aligned with the channel, wherein at least a first sidewall of the heat sink is exposed to the air within the bore;
an air quality sensor element including a sensor lens, disposed such at least the sensor lens is in the bore of the heat sink, and the sensor element is in thermally conductive contact with the heat sink;
wherein upon actuation, heat generated by operation of the air quality sensor element is conducted into the heat sink for release from the heat sink into the bore, thereby generating airflow through the channel.

15. The air quality sensor system of claim 14, wherein the at least one sidewall comprises a generally planar surface in front of the sensor lens.

16. The air quality sensor system of claim 15, wherein the bore has a polygonal shape along an axis parallel to the first opening and the second opening.

17. The air quality sensor system of claim 16, wherein the heat senor and the bore each have a generally square cross-sectional shape.

18. The air quality sensor system of claim 14, further comprising a lens member disposed in the bore in front of the sensor lens.

19. The air quality sensor system of claim 14, wherein the air quality senor is a laser particle counting sensor.

20. The air quality sensor system of claim 14, wherein the channel comprises a passage through the body.
